(19) United States
(12) Patent Application Publication
(10) Pub. No.: US 2013/0083665 A1
(43) Pub. Date: Apr. 4, 2013

(54) UNICAST TYPE NETWORK APPARATUS AND DATA TRANSMISSION AND RECEPTION METHOD THEREOF

(71) Applicants: Ji Hoon Kim, Suwon (KR); Bo Yle Seo, Gunpo (KR); Chung Hee Lee, Suwon (KR); Pankaj Razdan, Suwon (KR); Sung Ho Hwang, Suwon (KR); Sang Hyun Sim, Seoul (KR); Dae Gil Yoon, Seoul (KR); Seung Mo Kim, Seoul (KR)

(72) Inventors: Ji Hoon Kim, Suwon (KR); Bo Yle Seo, Gunpo (KR); Chung Hee Lee, Suwon (KR); Pankaj Razdan, Suwon (KR); Sung Ho Hwang, Suwon (KR); Sang Hyun Sim, Seoul (KR); Dae Gil Yoon, Seoul (KR); Seung Mo Kim, Seoul (KR)

(73) Assignee: SAMSUNG ELECTRO-MECHANICS CO., LTD.

(21) Appl. No.: 13/599,431

(22) Filed: Aug. 30, 2012

(30) Foreign Application Priority Data
Sep. 30, 2011 (KR) 10-2011-0099718

(51) Int. Cl. H04L 12/26

(52) U.S. Cl. 370/241

(57) ABSTRACT

There are provided a unicast type network apparatus having reduced power consumption, and a data transmission and reception method thereof. The unicast type network apparatus includes: a first device allowing link quality information between the first device and a reception side to be included in a data frame and then transmitting the data frame to the reception side, at the time of transmission of data; and a second device receiving the data frame from the first device and allowing link quality information between the second device and the first device to be included in an acknowledge frame in response to the data frame and then transmitting the acknowledge frame to the first device, when the link quality information is included in the data frame.

### CROSS-REFERENCE TO RELATED APPLICATIONS

This application claims the priority of Korean Patent Application No. 10-2011-0099718 filed on Sep. 30, 2011, in the Korean Intellectual Property Office, the disclosure of which is incorporated herein by reference.

### BACKGROUND OF THE INVENTION

1. Field of the Invention

The present invention relates to a unicast type network apparatus having reduced power consumption, and a data transmission and reception method thereof.

2. Description of the Related Art

Generally, “Zigbee” indicates IEEE 802.15.4 low-rate wireless personal area networks (LR-WPANs). A Zigbee system indicates a system that divides and uses a frequency band into three bands and performs communications by differently setting spreading schemes and data rates in each frequency band.

Zigbee is generally used for small sized, low power and low cost products and has been prominent as a technology for local area network market in wireless networks of about 10 to 20 m, such as homes, offices, and the like, and for ubiquitous computing.

FIG. 1 is a configuration diagram showing a schematic configuration of a general Zigbee network.

Referring to FIG. 1, a general Zigbee network 10 may include a Zigbee coordinator (ZC) 11 coordinating a network and at least one Zigbee devices (ZD) 12a to 12d connected to the Zigbee coordinator 11 to thereby perform a predetermined operation.

The Zigbee network 10 may further include a Zigbee router partially taking charge of a role of the Zigbee coordinator as needed.

The Zigbee coordinator 11 and the at least one Zigbee devices 12a to 12d, included the Zigbee network 10 transmit and receive predetermined signals according to the IEEE 802.15.4 protocol.

The transmitted and received signals may generally be a data frame. A data transmission method will be described with reference to FIG. 2.

FIG. 2 is a flow chart showing a broadcast type data transmission method of a general Zigbee network.

Referring to FIGS. 1 and 2, in the broadcast type data transmission method of the general Zigbee network, the Zigbee coordinator 11 first broadcasts a predetermined beacon in order to maintain a connection with the at least one Zigbee devices 12a to 12d surrounding the Zigbee coordinator 11 (S1).

Accordingly, a corresponding Zigbee device (one of the at least one Zigbee devices 12a to 12d) transmits a predetermined data frame to the Zigbee coordinator 11, and the Zigbee coordinator 11 transmits an acknowledge frame (ACK frame) corresponding to the data frame to the corresponding Zigbee device (S2).

Then, the Zigbee coordinator 11 broadcasts a beacon informing the at least one Zigbee devices 12a to 12d that data to be transmitted is present (S3).

Therefore, the corresponding Zigbee device transmits a data request frame to the Zigbee coordinator 11, and the Zigbee coordinator 11 transmits an acknowledge frame by setting a specific bit informing that data to be transmitted is present, to the corresponding Zigbee device that has transmitted the data request frame (S4).

Then, the Zigbee coordinator 11 transmits data that is to be transmitted to the corresponding Zigbee device, and the corresponding Zigbee device receiving the data transmits an acknowledge frame corresponding to the data to the Zigbee coordinator 11 (S5).

In the case in which data to be transmitted is additionally present, the third operation (S3) to the fifth operation (S5) are repeatedly performed to transmit the data (S6).

Meanwhile, unlike the method of transmitting and receiving data in the broadcasting scheme in the Zigbee network described above, data may be transmitted and received in a unicast scheme.

FIG. 3 is a diagram showing general unicast type data transmission and reception between devices.

Referring to FIG. 3, in data transmission between a first device A and a second device B, the first device A first transmits data frame 1 to the second device 2.

The second device B receives the data frame 1 and then transmits an acknowledge frame 2 to the data frame 1.

Then, in the case in which data that the second device B is to transmit is present, the second device B transmits a data frame 3 to the first device A, and the first device A transmits an acknowledge frame 4, in response to the data frame 3, to the second device B.

At the time of the transmission and reception of data between the first and second devices A and B, link quality information indicating the quality of a link performing communication between the devices may be included.

That is, the first device A may allow link quality information regarding the second device B from a point of view of the first device A to be included in the data frame 1 transmitted from the first device A, and the second device B may allow link quality information regarding the first device A from a point of view of the second device B to be included in the subsequent data frame 3.

As described above, in the unicast type network apparatus according to the related art, in the case of transmitting data between devices, particularly, in the case of transmitting and receiving link quality information, the transmission and reception of frames including the data frame and the acknowledge frame are performed four times in total, such that a time delay occurs in data transmissions and an excessive amount of power is consumed.

### SUMMARY OF THE INVENTION

An aspect of the present invention provides a unicast type network apparatus allowing link quality information to be included in an acknowledge frame and then transmitting data, and a data transmission and reception method thereof.

According to an aspect of the present invention, there is provided a unicast type network apparatus including: a first device allowing link quality information between the first device and a reception side to be included in a data frame and then transmitting the data frame to the reception side, at the time of transmission of data; and a second device receiving the data frame from the first device and allowing link quality information between the second device and the first device to be included in an acknowledge frame in response to the data frame and then transmitting the acknowledge frame to the first device, when the link quality information is included in the data frame.

The first and second devices may transmit the data frame or the acknowledge frame through different frequency channels.

The first device may allow link quality information regarding a preset first channel to be included in the data frame and then transmit the data frame to the second device through the first channel.

The second device may allow link quality information regarding a second channel, set as a frequency channel different from the first channel, to be included in the acknowledge frame and then transmit the acknowledge frame to the first device through the second channel.

The acknowledge frame may include a media access control (MAC) header area, a payload area, and an MAC footer area, and the link quality information regarding the second channel may be included in the payload area.

According to another aspect of the present invention, there is provided a data transmission and reception method of first and second devices transmitting and receiving data in a unicast scheme, the data transmission and reception method including: allowing link quality information regarding the second device, from a point of view of the first device, to be included in a data frame and then transmitting the data frame from the first device to the second device; and allowing link quality information regarding the first device, from a point of view of the second device, to be included in an acknowledge frame to the data frame and then transmitting the acknowledge frame from the second device to the first device, when the link quality information regarding the second device, from the point of view of the first device, is included in the data frame.

The transmitting of the data frame from the first device to the second device may include allowing, in the first device, link quality information regarding a preset first channel to be included in the data frame and then transmitting the data frame to the second device through the first channel.

The transmitting of the acknowledge frame from the second device to the first device may include allowing, in the second device, link quality information regarding a second channel, set as a frequency channel different from that of the first channel, to be included in the acknowledge frame and then transmitting the acknowledge frame to the first device through the second channel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general Zigbee network;

FIG. 2 is a flow chart showing a data transmission method of a general Zigbee network;

FIG. 3 is a diagram showing general unicast type data transmission and reception between devices;

FIG. 4 is a diagram showing a data reception method of a network apparatus according to an embodiment of the present invention;

FIG. 5 is a diagram showing data transmission and reception of the network apparatus according to the embodiment of the present invention; and

FIG. 6 is a configuration diagram of a frame used in the network apparatus according to the embodiment of the present invention.

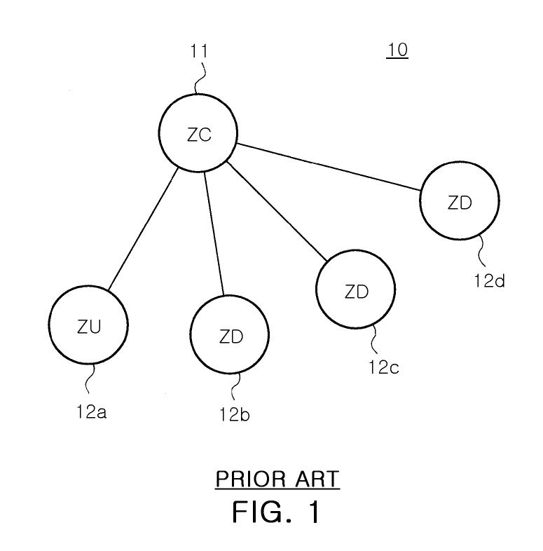

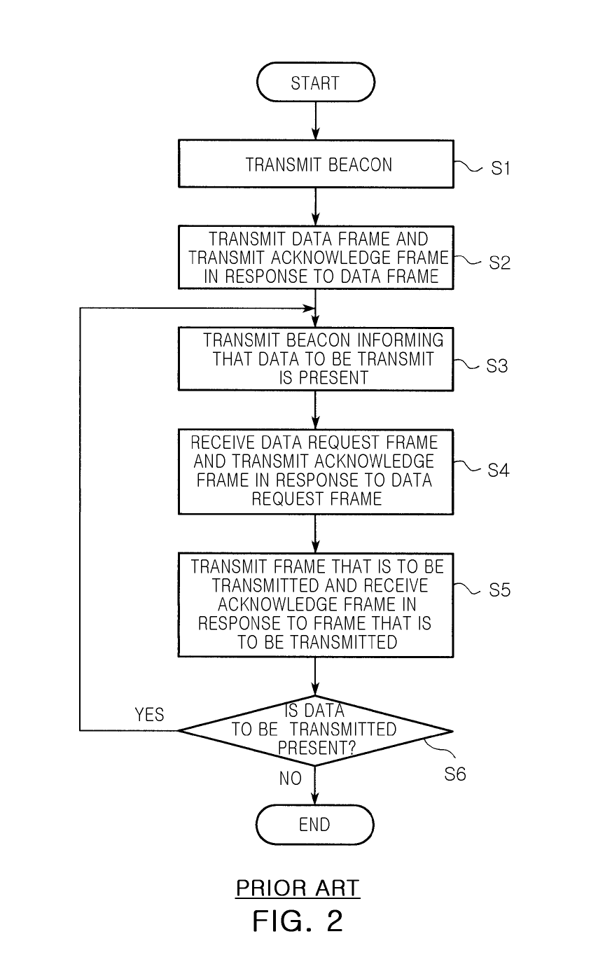

### DETAILED DESCRIPTION OF THE INVENTION

Embodiments of the present invention will now be described in detail with reference to the accompanying drawings.

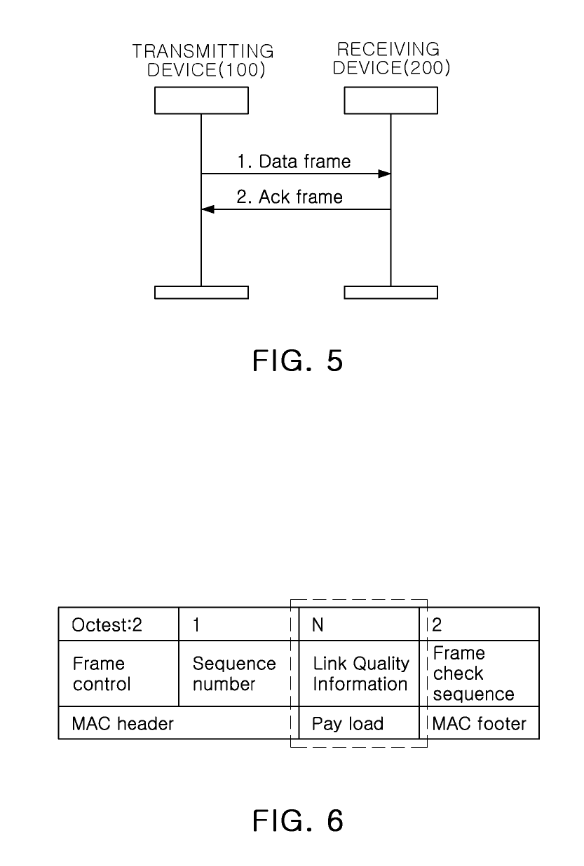

FIG. 4 is a diagram showing a data reception method of a network apparatus according to an embodiment of the present invention; and FIG. 5 is a diagram showing data transmission and reception of the network apparatus according to the embodiment of the present invention.

Referring to FIGS. 4 and 5, the network apparatus according to the embodiment of the present invention may include first and second devices 100 and 200.

The first and second devices 100 and 200 may transmit and receive a data frame to/from each other in a unicast scheme.

In transmitting and receiving the data frame, the unicast scheme may be a communications scheme between a single transmitter and a single receiver on a network. The unicast scheme may be different from a multicast scheme, which is a communications scheme between a single transmitter and multiple receivers, or a broadcast scheme, which is a communications scheme between any group of transmitters and receivers on a network, and have a meaning similar to a point-to-point communications scheme that has been previously used.

That is, the unicast scheme, which is a one-to-one (1:1) communications scheme between a transmitting device and a receiving device on a network, is not a scheme of transmitting a data frame to each of a plurality of receiving devices but maybe a scheme of transmitting a data frame to a specified single receiving device. Unlike this, the multicast scheme means a communications scheme in which a single transmitting device transmits a data frame to multiple specific receiving devices, and the broadcasting scheme means a communications scheme in which a single transmitting device transmits a data frame to multiple unspecific receiving devices.

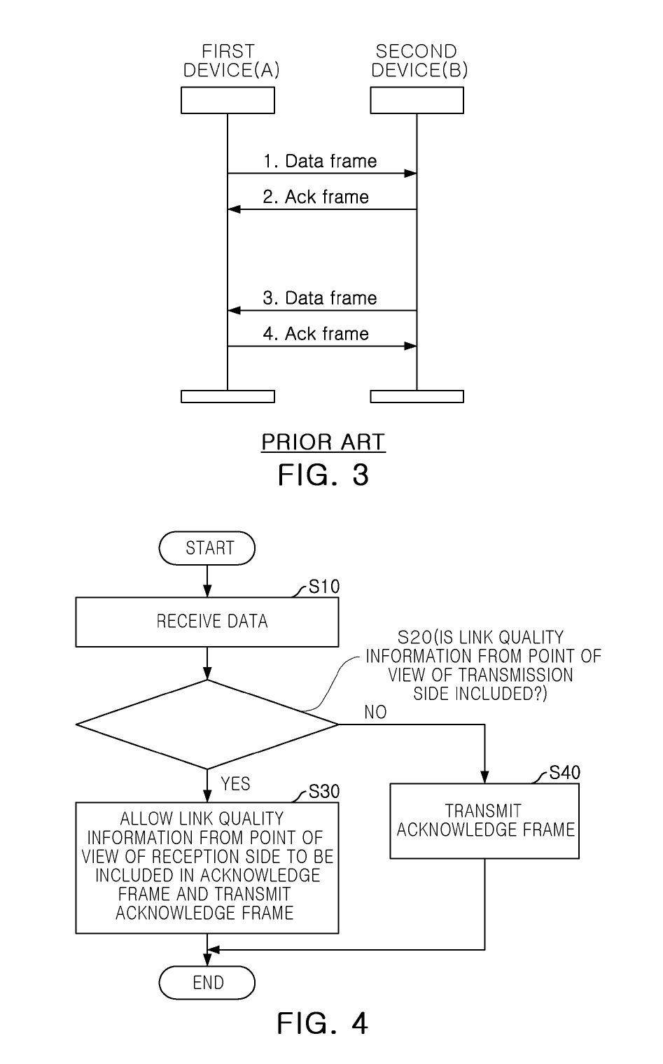

The above-mentioned unicast scheme maybe described as shown in FIG. 3.

In data transmission between the first device A and the second device B, in the case in which the first device A is to transmit data, the first device A may first transmit the data frame 1 to the second device B.

Then, the second device B receives the data frame 1 and then transmits an acknowledge frame 2 to the data frame 1.

Then, in the case in which data that the second device B is to transmit is present, the second device B transmits the data frame 3 to the first device A, and the first device A transmits the acknowledge frame 4 in response to the data frame 3 to the second device B.

At the time of transmission and reception of data between the first and second devices A and B, link quality information indicating quality of a link performing communications between the devices may be included.

That is, the first device A may allow link quality information regarding the second device B from a point of view of the first device A to be included in the data frame 1 transmitted from the first device A, and the second device B may allow link quality information regarding the first device

A from a point of view of the second device B to be included in the subsequent data frame 3.

The reason of allowing the link quality information to be included in the data frames as described above is that channels transmitting the data frames between the first and second devices A and B are different.

That is, a channel transmitting the data frame or the acknowledge frame from the first device A to the second device B may be different from another channel transmitting the acknowledge frame or the data frame from the second device B to the first device A.

Therefore, that is, the first device A may transmits link quality information indicating quality information regarding the channel transmitting the data frame or the acknowledge frame from the first device A to the second device B and the channel transmitting the acknowledge frame or the data frame from the second device B to the first device A, to the second device B, and the second device B may transmit the link quality information to the first device A.

However, as described above, in the general unicast type data transmission and reception method, in the case of transmitting and receiving the data frame that is to be transmitted between the first and second devices A and B, particularly, the link quality information, the transmission and reception of the frames are performed four times in total.

Since the first and second devices A and B need to be in an operation state during a process in which the transmission and reception of the frames is performed four times, large power consumption may be generated.

Therefore, as shown in FIGS. 4 and 5, in the unicast type data transmission and reception method according to the embodiment of the present invention, in the case in which data that the first device 100 is to transmit to a second device 200 is present, the first device 100 first transmits the data frame 1 to the second device 200. Therefore, the second device 200 receives the data frame 1 from the first device 100 (S10).

The second device 200 may confirm whether link quality information is included in the data frame 1 received from the first device 100 (S20).

Here, the link quality information may be link quality information regarding the second device 200 from a point of view of the first device 100.

When the link quality information is included in the data frame 1 received from the first device 100, the second device 200 may transmit the acknowledge frame 2 in response to the data frame 1 to the first device 100. At this time, the second device 200 may allow link quality information to be included in the acknowledge frame 2 and then transmit the acknowledge frame 2 (S30).

When the link quality information is not included in the data frame 1 received from the first device 100, the second device 200 may transmit only the acknowledge frame 2 to the data frame 1 to the first device 100 (S40).

FIG. 6 is a configuration diagram of a frame used in the network apparatus according to the embodiment of the present invention.

Referring to FIGS. 4 through 6, the acknowledge frame may include a media access control (MAC) header area, a payload area, and an MAC footer area, and link quality information regarding the second channel may be included in the payload area.

Meanwhile, as described above, in the network apparatus according to the embodiment of the present invention, the first and second device 100 and 200 may transmit the data frame or the acknowledge frame through different frequency channels. That is, the channel transmitting the data frame from the first device 100 to the second device 200 may be different from the channel transmitting the acknowledge frame from the second device 200 to the first device 100.

More specifically, the first device 100 may transmit link quality information regarding the first channel transmitting the data frame from the first device 100 to the second device 200, to the second device 200, and the second device 200 may transmit link quality information regarding the second channel transmitting the acknowledge frame from the second device 200 to the first device 100, to the first device 100.

Therefore, two-way communications between the first and second devices 100 and 200 may be secured.

As set forth above, according to the embodiments of the present invention, the link quality information is included in the acknowledge frame and the data is then transmitted, such that when the link quality information is transmitted and received in transmitting the data, the transmission and reception of the frames including the data frame and the acknowledge frame is performed two times, whereby the time delay maybe prevented, the power consumption maybe reduced, and the two-way communications may be secured.

While the present invention has been shown and described in connection with the exemplary embodiments, it will be apparent to those skilled in the art that modifications and variations can be made without departing from the spirit and scope of the invention as defined by the appended claims.

What is claimed is:

1. A unicast type network apparatus comprising:
a first device allowing link quality information between the first device and a reception side to be included in a data frame and then transmitting the data frame to the reception side, at the time of transmission of data; and
a second device receiving the data frame from the first device and allowing link quality information between the second device and the first device to be included in an acknowledge frame in response to the data frame and then transmitting the acknowledge frame to the first device, when the link quality information is included in the data frame.

2. The unicast type network apparatus of claim 1, wherein the first and second devices transmit the data frame or the acknowledge frame through different frequency channels.

3. The unicast type network apparatus of claim 2, wherein the first device allows link quality information regarding a preset first channel to be included in the data frame and then transmits the data frame to the second device through the first channel.

4. The unicast type network apparatus of claim 3, wherein the second device allows link quality information regarding a second channel, set as a frequency channel different from the first channel, to be included in the acknowledge frame and then transmits the acknowledge frame to the first device through the second channel.

5. The unicast type network apparatus of claim 4, wherein the acknowledge frame includes a media access control (MAC) header area, a payload area, and an MAC footer area, and
the link quality information regarding the second channel is included in the payload area.

6. A data transmission and reception method of first and second devices transmitting and receiving data in a unicast scheme, the data transmission and reception method comprising:
allowing link quality information regarding the second device, from a point of view of the first device, to be included in a data frame and then transmitting the data frame from the first device to the second device; and
allowing link quality information regarding the first device, from a point of view of the second device, to be included in an acknowledge frame to the data frame and then transmitting the acknowledge frame from the second device to the first device, when the link quality information regarding the second device, from the point of view of the first device, is included in the data frame.

7. The data transmission and reception method of claim 6, wherein the first and second devices transmit the data frame or the acknowledge frame through different frequency channels.

8. The data transmission and reception method of claim 7, wherein the transmitting of the data frame from the first device to the second device includes allowing, in the first device, link quality information regarding a preset first channel to be included in the data frame and then transmitting the data frame to the second device through the first channel.

9. The data transmission and reception method of claim 8, wherein the transmitting of the acknowledge frame from the second device to the first device includes allowing, in the second device, link quality information regarding a second channel, set as a frequency channel different from that of the first channel, to be included in the acknowledge frame and then transmitting the acknowledge frame to the first device through the second channel.

10. The data transmission and reception method of claim 9, wherein the acknowledge frame includes an MAC header area, a payload area, and an MAC footer area, and
the link quality information regarding the second channel is included in the payload area.
